(19) United States
(12) Patent Application Publication
(10) Pub. No.: US 2026/0259752 A1
(43) Pub. Date: Sep. 3, 2026

(54) COMPUTING DEVICE AND METHODS PROVIDING INPUT SEQUENCE TRANSLATION FOR VIRTUAL COMPUTING SESSIONS

(71) Applicant: CITRIX SYSTEMS, INC., Fort Lauderdale, FL (US)

(72) Inventors: Zongpeng Qiao, NANJING (CN); Ke Xu, NANJING (CN); Ze Chen, NANJING (CN); Zihao Zhou, NANJING (CN)

(21) Appl. No.: 18/873,071

(22) PCT Filed: Sep. 20, 2022
(86) PCT No.: PCT/CN2022/119819

§ 371 Date: Dec. 9, 2024

(51) Int. Cl. G06F 9/451; G06F 3/01; G06F 3/16

(52) U.S. Cl. CPC G06F 9/452; G06F 3/017; G06F 3/16

(57) ABSTRACT

A computing device may include a memory and a processor cooperating with the memory to run a program, receive a first sequence of inputs from at least one input device for the program, and learn a relationship between an action performed by the program and the first sequence of inputs. The processor may be further configured to access a remote virtual computing session in which the action is performed responsive to a second sequence of inputs different than the first sequence of inputs, and upon receipt of the first sequence of inputs from the at least one input device while accessing the remote virtual computing session, cause the virtual computing device to perform the action based upon the learned relationship.

### BACKGROUND

Web applications or apps are software programs that run on a server and are accessed remotely by client devices through a Web browser. That is, while Web applications have a similar functionality to native applications installed directly on the client device, Web applications are instead installed and run on the server, and only the browser application is installed on the client device. Although in some implementations, a hosted browser running on a virtualization server may be used to access Web applications as well.

One advantage of using Web applications is that this allows client devices to run numerous different applications without having to install all of these applications on the client device. This may be particularly beneficial for thin client devices, which typically have reduced memory and processing capabilities. Moreover, updating Web applications may be easier than native applications, as updating is done at the server level rather than having to push out updates to numerous different types of client devices.

Software as a Service (SaaS) is a Web application licensing and delivery model in which applications are delivered remotely as a web-based service, typically on a subscription basis. SaaS is used for delivering several different types of business (and other) applications, including office, database, accounting, customer relation management (CRM), etc.

### SUMMARY

A computing device may include a memory and a processor cooperating with the memory to run a program, receive a first sequence of inputs from at least one input device for the program, and learn a relationship between an action performed by the program and the first sequence of inputs. The processor may be further configured to access a remote virtual computing session in which the action is performed responsive to a second sequence of inputs different than the first sequence of inputs, and upon receipt of the first sequence of inputs from the at least one input device while accessing the remote virtual computing session, cause the remote virtual computing session to perform the action based upon the learned relationship.

In an example embodiment, the processor may be configured to learn the relationship upon receiving the first sequence of inputs a plurality of times. In some embodiments, the processor may be further configured to generate a user interface including a prompt to confirm learning of the relationship. Furthermore, the processor may also be configured to cause the program to perform the action upon receipt of the first sequence of inputs from the at least one input device while accessing the virtual computing session in some embodiments. In an example implementation, the processor may be further configured to communicate with a management service to remotely store the learned action for use on other computing devices.

By way of example, the at least one input device may comprise an audio input device, and the first sequence of inputs may comprise a sequence of spoken words. In accordance with another example, the at least one input device may comprise a motion sensor, and the first sequence of inputs may comprise a sequence of motions. In yet another example implementation, the at least one input device may comprise a keypad, and the first sequence of inputs may comprise a sequence of keystrokes.

A related method may include, at a computing device, running a program, receiving a first sequence of inputs from at least one input device for the program, and learning a relationship between an action performed by the program and the first sequence of inputs. The method may further include, at the computing device, accessing a remote virtual computing session in which the action is performed responsive to a second sequence of inputs different than the first sequence of inputs, and upon receipt of the first sequence of inputs from the at least one input device while accessing the remote virtual computing session, causing the virtual computing device to perform the action based upon the learned relationship.

A related non-transitory computer-readable medium may have computer-executable instructions for causing a computing device to perform steps including running a program, receiving a first sequence of inputs from at least one input device for the program, and learning a relationship between an action performed by the program and the first sequence of inputs. The steps may further include accessing a remote virtual computing session in which the action is performed responsive to a second sequence of inputs different than the first sequence of inputs, and upon receipt of the first sequence of inputs from the at least one input device while accessing the remote virtual computing session, causing the virtual computing device to perform the action based upon the learned relationship.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web-based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computing device providing intended action learning and translation features in accordance with an example embodiment.

FIG. 7 is a schematic block diagram of an example implementation of the computing device of FIG. 6 performing user behavior learning in accordance with different example input scenarios.

FIG. 8 is a schematic block diagram of an example implementation of the computing device of FIG. 6 within a workspace environment.

FIG. 9 is a sequence flow diagram illustrating example steps performed by the components within the implementation of FIG. 8.

FIG. 10 is a partial screen print illustrating learning of a new action by the computing device of FIG. 6 in an example embodiment.

FIGS. 11 and 12 are example popup windows which may be provided within a user interface (UI) by the computing device of FIG. 6 to perform clarification of user intent.

FIG. 13 is a flow diagram illustrating method aspects associated with the computing device of FIG. 6.

### DETAILED DESCRIPTION

Users become accustomed to the particular input sequences of the operating system (OS) and associated programs they use most (e.g., Windows or MacOS). However, some OS's are designed to operate with keyboards that have different function keys. Thus, while most operating systems perform common functions such as copy, cut, paste, etc., it requires a completely different sequence of key strokes to perform the given function in an app(s) on one OS than it does the same app(s) on another OS. As such, when users who are very accustomed and comfortable with one OS need to use a program running within a different operating system, this can be a significant source of frustration for the user. For example, some if not all of the shortcut habits the user has learned within the first OS will not work within the second OS. One scenario where this may occur is when users access virtual computing sessions running within one OS, from a client device running a different OS. By way of example, the virtual sessions may include a virtual app/desktop session, Desktop as a Service (DaaS) session, Software as a Service (SaaS) session, etc., running on a Windows server, but which are accessed from a client device running MacOS. In such case, some or all of the shortcut key strokes the user enters on the MacOS client device will not achieve the intended actions within the Windows-based virtual computing session. Furthermore, custom shortcuts or macros the user builds in MacOS will also not work in the Windows-based virtual computing session.

The approach set forth herein overcomes these technical challenges by learning an intended action of a user, e.g., within a first OS, and then causing that same intended action to be performed for the user within a virtual computing session that would not otherwise recognize the intended action. That is, the present approach provides a way to record a user's shortcut and corresponding intention, and apply that same intention into other systems/applications without any behavior change on the part of the user.

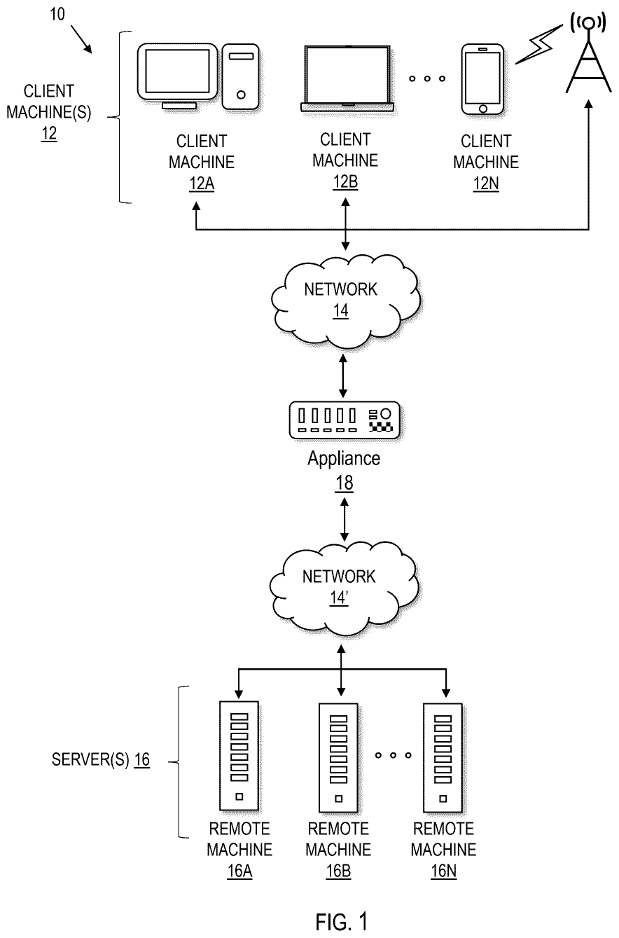

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 108 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

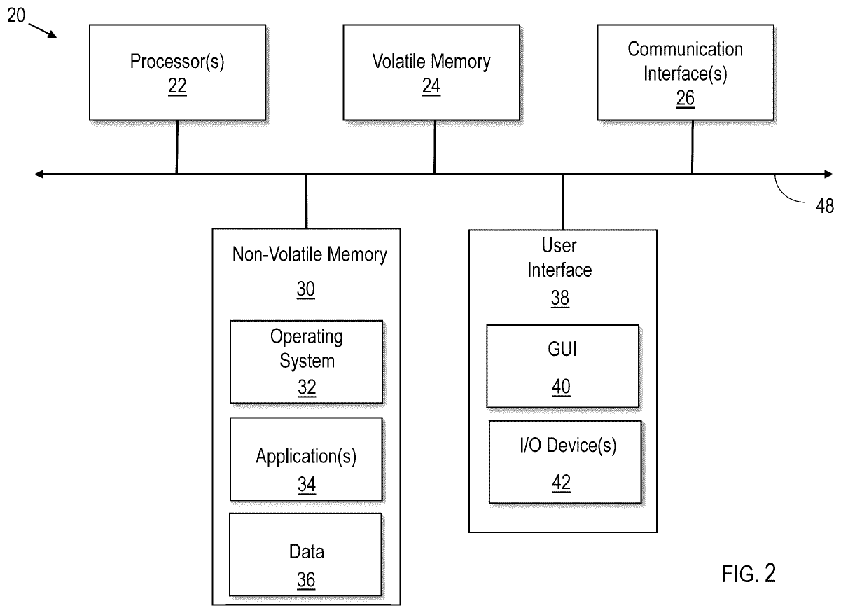

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Florida (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

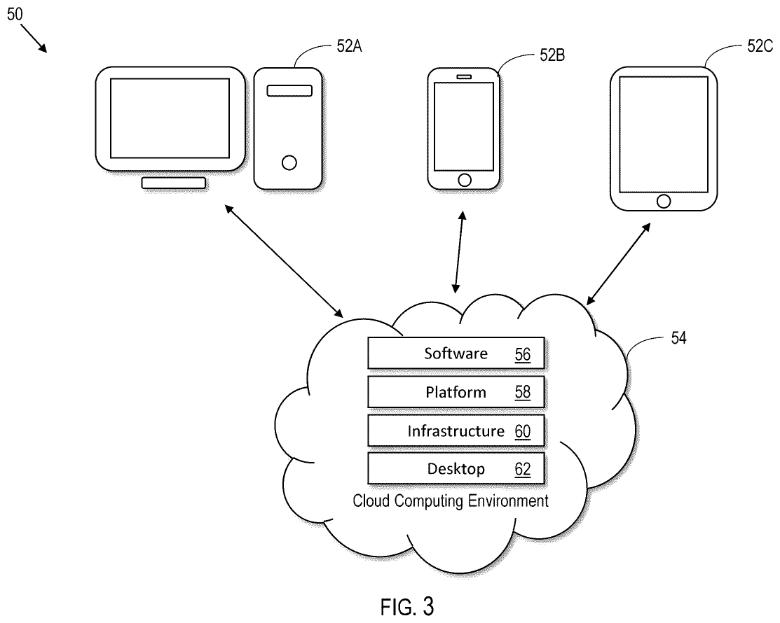

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app (CWA) may be used as a single-entry point for bringing apps, files and desktops together (whether on-premises or in the cloud) to deliver a unified experience.

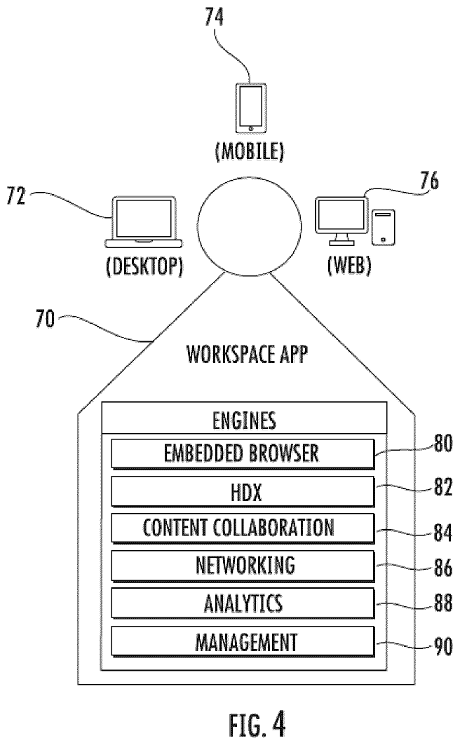

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific μ-VPN connection. A μ-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

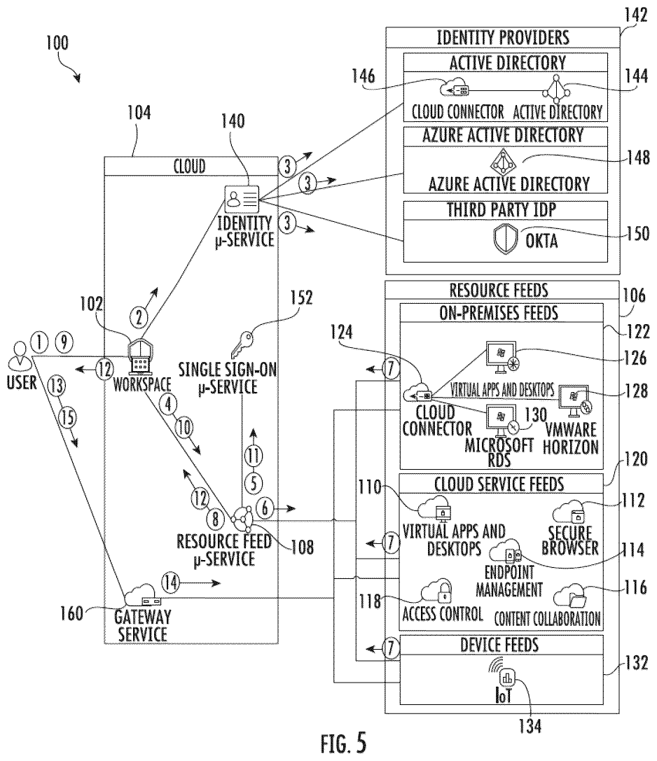

Referring now to FIG. 5, a workspace network environment 100 providing a unified experience to a user based on the workspace app 70 will be discussed. The desktop, mobile and web versions of the workspace app 70 all communicate with the workspace experience service 102 running within the Cloud 104. The workspace experience service 102 then pulls in all the different resource feeds 16 via a resource feed micro-service 108. That is, all the different resources from other services running in the Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Cloud 104, and presenting their identity (event 1). The identity includes a username and password, for example.

The workspace experience service 102 forwards the user's identity to an identity micro-service 140 within the Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

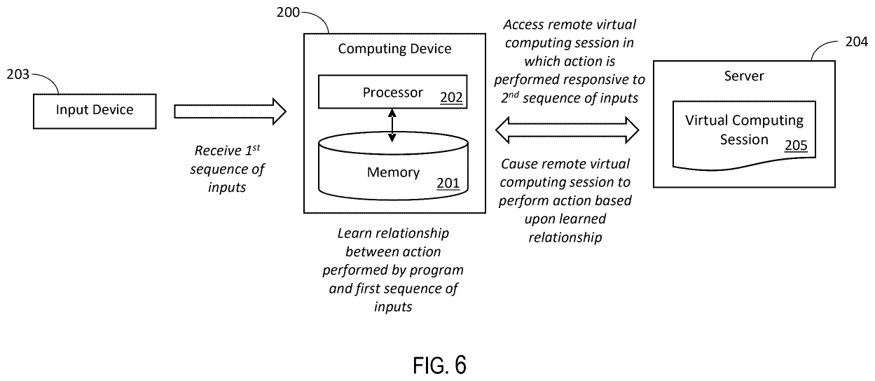

Turning now to FIG. 6, a computing device 200 illustratively includes a memory 201 and a processor 202 cooperating with the memory to run a program (e.g., an operating system (OS), application, etc.), receive a first sequence of inputs from at least one input device 203 for the program, and learn a relationship between an action performed by the program and the first sequence of inputs. The processor 202 may be further configured to access a remote virtual computing session 204 in which the action is performed responsive to a second sequence of inputs different than the first sequence of inputs. That is, the virtual computing session 204 is remote in the sense that it is run at a remote computer or server 205, but accessed locally at the computing device 202, such as through a browser or Web app, for example. Upon receipt of the first sequence of inputs from the input device(s) 203 while accessing the remote virtual computing session 204, the processor 202 causes the remote virtual computing session 204 to perform the action based upon the learned relationship.

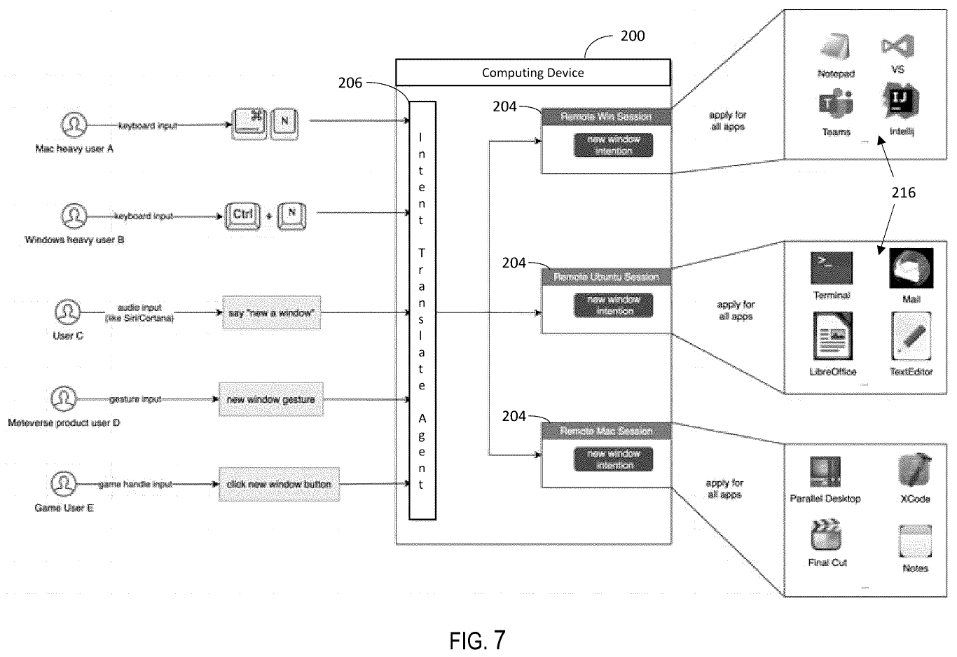

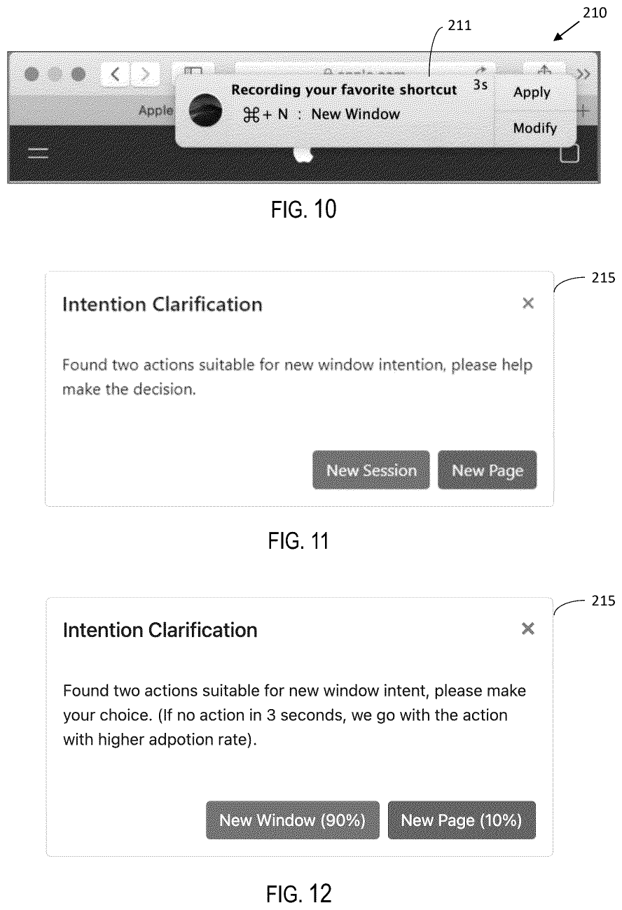

Generally speaking, the computing device 200 provides for recording of a user's shortcut and the corresponding intention associated with the shortcut to perform a particular action, along with application of the same intention into other operating systems/applications without any behavior change by the user. Referring additionally to FIG. 7, in this example implementation the computing device 200 is a Mac computer (e.g., iMac, Macbook, etc.) running CWA, as discussed further above. When a Mac heavy user A uses a particular shortcut key sequence several times, the computing device 200 will record the user's behavior and notify the user of the recorded shortcut and corresponding action. In the example screen print 210 of FIG. 10, a key sequence of [command key]+N has been used several times, which is the default Mac OS key sequence for opening a new window. A popup window 211 is provided (see FIG. 10) allowing the user to apply or modify the mapping relationship that has been identified. However, it should be noted that in some embodiments the popup window 211 need not be provided, and the action may be automatically recorded or learned without user input.

In the present example, once the user selects “apply”, the mapping relationship is stored in CWA as well as in Citrix Cloud, as will be discussed further below. When the user launches a Citrix Virtual Delivery Agent (VDA) session, the mapping relationship will continue to work in the background. As such, when the user accesses the remote virtual computing session 204 from the Windows server 205 and he/she presses the same shortcut (here [command key]+N), the Windows OS running at the server may then perform the same intended action of opening a new window within the virtual computing session. That is, the user's intention, although otherwise unrecognizable to the Windows OS, will now automatically be translated into the desired new window behavior and applied throughout the virtual computing session 204 (e.g., across one or more applications 216 within the virtual computing session, such as in the case of a DaaS session). It should be noted however, that the approach described herein may be used with other virtualization or Cloud services besides Citrix Cloud and Workspace/CWA.

This approach may also be used for learning numerous other input sequences and the associated actions intended by the user, and may be used with other types of computing devices 200 and virtual computing sessions 204 utilizing different operating systems than those noted above. Continuing with the example of FIG. 7, a keyboard sequence of Ctrl+N repeatedly entered by a Windows heavy user B is similarly learned or recorded as the user's intended new window shortcut, which can then be applied in a remote Umbutu or Mac session, along with the example associated applications shown (as well as others).

Moreover, in addition to collecting keyboard or touchpad data such as keyboard shortcuts for learning a user's intended action, other input devices may be used as well. For example, User C can leverage an audio channel to speak out his or her intended action via an audio input device (e.g., microphone), such as “new window” to generate the same new window intention. In still another example, Metaverse product user D may define a gesture and/or physical keys via a motion activated controller to associate his or her intended action, which may advantageously help boost working efficiency. In still another example scenario, there may be similar difficulties for gamers moving between different gaming platforms (e.g., PlayStation and Xbox). Here, game User E also leverages a game controller to apply a similar sequence of inputs to be learned as an intended action.

In the illustrated example, the processor 202 runs an intent translate agent 206 which is located in the user's local system. In the present example, the intent translate agent 206 is implemented within CWA, and it performs various functions. One of its functions is to monitor the user's shortcut behavior and record the corresponding intended action automatically. This may be accomplished by analyzing the frequency of each shortcut behavior and recording frequently used shortcuts (along with the corresponding intention), and optionally providing the popup notification 211 as shown in FIG. 10. The intent translate agent 206 further supports defining mapping relationships between input sequences (e.g., gesture/game controller/virtual reality (VR) controller/touchpad, etc.) and intention manually. That is, the intent translate agent 206 may obtain default input sequences (e.g., Crtl+N, etc.) for an OS from a database of such input sequences and associated actions, and/or learn custom user-defined input sequences and associated actions which the user intends to perform by the action.

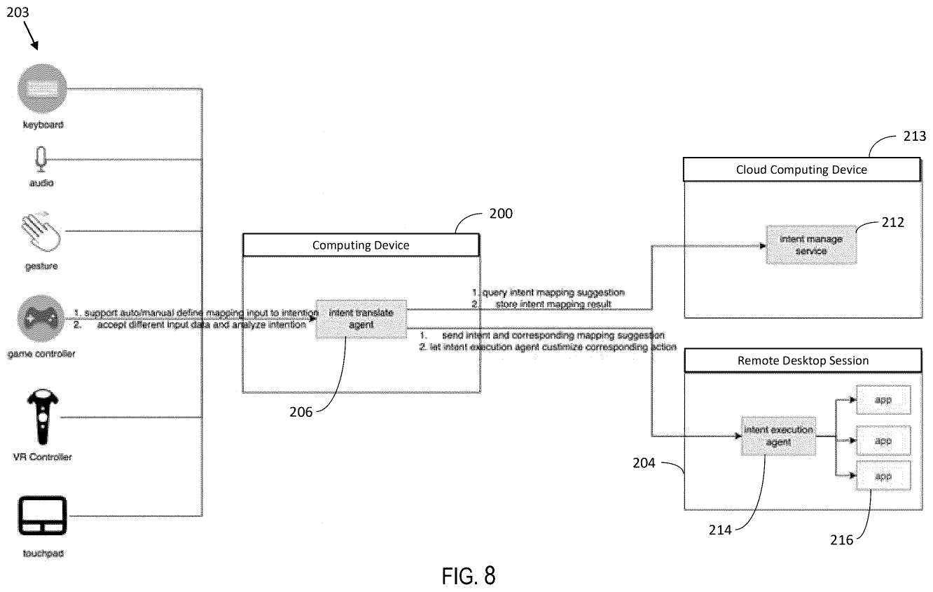

Referring additionally to FIG. 8, the intent translate agent 206 may also accept different input data and analyze the user's intention by involving a Cloud-based intent manage service 212 (here running within Citrix Cloud 213, though other cloud services may be used in different embodiments). The intent translate agent 206 may further send intention mapping suggestions to an intent execution agent 214, which in the illustrated example is running within the remote virtual computing session 204 (a remote desktop session running various apps 216 in the illustrated example), as will be discussed further below. Another function of the intent translate agent 206 may be that, if ambiguous mappings are found by the intent execution agent 214, it may provide a dialog box 215 (see FIGS. 11 and 12) to allow the user to make a decision as to the proper action he or she wishes to perform, and update the learned or recorded result to the intent management service 212 for future reference.

More particularly, the intent management service 212 is configured to store the mapping info from the intent translate agent 206 in a database, and re-analyze/update mapping information when a decision is made by the user concerning an ambiguous mapping. The intent management service 212 may also send intention mapping information responsive to requests from the intent translate agent 206. This may be advantageous when a user has multiple different computing (client) devices 200 from which he or she works, all of which are associated with the user's account, so that input sequences and associated intended actions learned on one client device may be made automatically available at another client device.

By way of example, the intent execution agent 214 may be deployed at a VDA to listen to messages from the intent translate agent 206 and translate the intention into the corresponding intended action in the remote session 204. The action may be in different existing formats. For example, the action may be from an application or operating system directly. It may also be customized by a user/admin at the VDA, such as with a customized script to dynamically decide if the file is saved locally, in another cloud service like Dropbox, or both.

Various approaches may be used to collect shortcuts for applications in a given OS. For example, online public databases may be leveraged directly to obtain tables of default shortcuts for a particular application based upon the given OS. Another approach is to leverage an operating system Application Programming Interface (API) to obtain the shortcut for the application. For example, in MacOS Cocoa API may be used to retrieve menu keyboard shortcuts for the current application. Additionally, for most applications, shortcuts are stored as key-value pairs in a configuration file along with the deployment of the application, and mapping data may also be retrieved from this configuration file. For example, in Virtual Studio (VS) Code, when a user customizes a shortcut, the key-value pairs will be stored into a file named keybingings.json. For VS Code, this file may be found under the folder $HOME\AppData\Roaming\Code\User\keybingings.json).

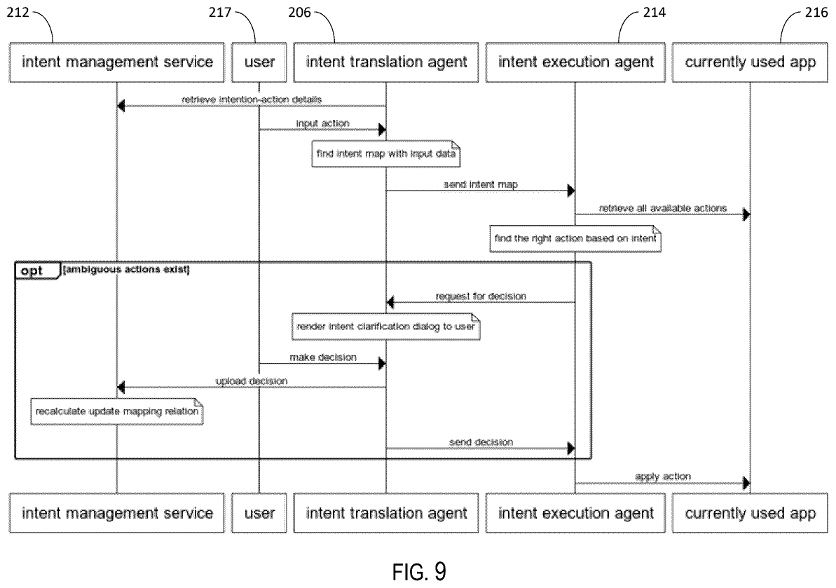

Referring additionally to FIG. 9, to find the desired intended action in the remote session, an action-name pool may be maintained for every intention by the intent translate agent 206 and/or the intent management service 212. Initially, there may be only one action for the intention which is communicated from the intent translate agent 206 to the intent management service 212 (e.g., {‘newWindowIntention’: [‘new window’]}). When the user 217 tries to apply the same intention into an application in the remote session 204, the intent translate agent finds the intent map based upon the input date and sends the intent map to the execution agent 214. The action name in the pool is mapped with actions from the currently used application 216. The intent execution agent 214 then seeks to find the right action based upon the intent of the user 217. More particularly, if any action-name in the pool matches an action from the application completely, the action will be applied directly. If not, the intent execution agent 214 will try to compare the composition of the action name (e.g., [“new window”] is a composition of verb+noun). If the action-name in the pool has the same composition as the action name from the application 216, then the associated action may be applied. Otherwise, the action may also be applied, and the new action name may be saved into the action-name pool, or the intent execution agent 214 may seek user confirmation is discussed further below.

By way of example, in MS Word there are two actions related to newWindowIntention intention: “new Document” and “new from template”. A composition comparison may be used to find that only one action is matched which is “new Document” (“new from template” is a composition of verb+adv+noun). Then the action will be applied in Word and stored in the action pool as {“newWindowIntention”: [“new window”, “new document” ]}). If less than all terms are matched, meaning the results are ambiguous, then a user decision may be solicited to let the user decide the appropriate result, which may then be applied and the new relationship stored accordingly. For example, if two actions are found related to newWindowIntention (like “new session” and “new page”), it may be determined that both actions are of the same composition. So, a dialog box 215 is provided for the user to choose. Once the user makes the choice, the appropriate action is performed and the action pool is updated accordingly.

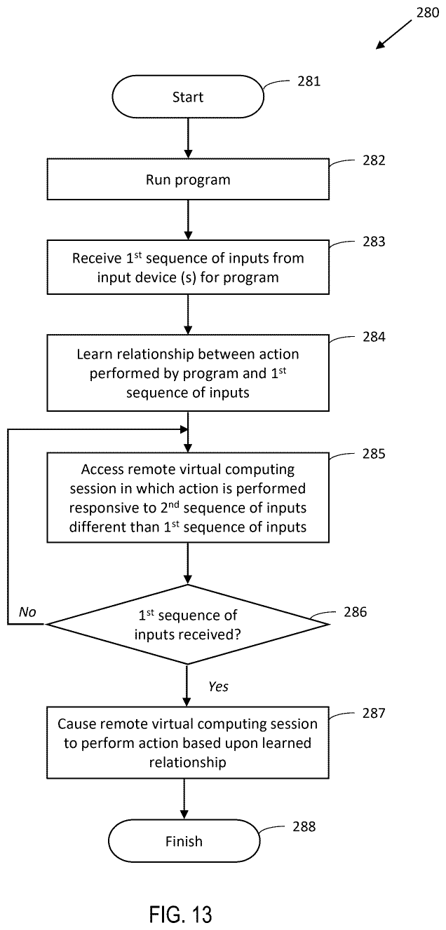

Turning to the flow diagram 280 of FIG. 13, a related method is now described. Beginning at Block 281, the computing device 200 runs the program (e.g., OS, application, etc.), at Block 282, and receives the first sequence of inputs from the input device(s) 203 for the program, at Block 283. Furthermore, the computing device 200 learns a relationship between an action performed by the program and the first sequence of inputs, at Block 284, as discussed further above. The computing device 200 further accesses the remote virtual computing session 204 in which the action is performed responsive to a second sequence of inputs different than the first sequence of inputs (e.g., because it operates on a different OS, etc.), at Block 285. Upon receipt of the first sequence of inputs from the at least one input device 203 while accessing the remote virtual computing session 204 (Block 286), the computing device 200 causes the remote virtual computing sessions to perform the action based upon the learned relationship (Block 287), as also discussed further below. The method of FIG. 13 illustratively concludes at Block 288.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A computing device comprising:
a memory and a processor cooperating with the memory to
run a program,
receive a first sequence of inputs from at least one input device for the program,
learn a relationship between an action performed by the program and the first sequence of inputs,
access a remote virtual computing session in which the action is performed responsive to a second sequence of inputs different than the first sequence of inputs, and
upon receipt of the first sequence of inputs from the at least one input device while accessing the remote virtual computing session, cause the remote virtual computing session to perform the action based upon the learned relationship.

2. The computing device of claim 1 wherein the processor is configured to learn the relationship upon receiving the first sequence of inputs a plurality of times.

3. The computing device of claim 1 wherein the processor is further configured to generate a user interface including a prompt to confirm learning of the relationship.

4. The computing device of claim 1 wherein the processor is further configured to cause the program to also perform the action upon receipt of the first sequence of inputs from the at least one input device while accessing the virtual computing session.

5. The computing device of claim 1 wherein the processor is further configured to communicate with a management service to remotely store the learned action for use on other computing devices.

6. The computing device of claim 1 wherein the at least one input device comprises an audio input device, and the first sequence of inputs comprises a sequence of spoken words.

7. The computing device of claim 1 wherein the at least one input device comprises a motion sensor, and the first sequence of inputs comprises a sequence of motions.

8. The computing device of claim 1 wherein the at least one input device comprises a keypad, and the first sequence of inputs comprises a sequence of keystrokes.

9. A method comprising:
at a computing device,
running a program,
receiving a first sequence of inputs from at least one input device for the program,
learning a relationship between an action performed by the program and the first sequence of inputs,
accessing a remote virtual computing session in which the action is performed responsive to a second sequence of inputs different than the first sequence of inputs, and
upon receipt of the first sequence of inputs from the at least one input device while accessing the remote virtual computing session, causing the virtual computing device to perform the action based upon the learned relationship.

10. The method of claim 9 wherein learning comprises learning the relationship upon receiving the first sequence of inputs a plurality of times.

11. The method of claim 9 further comprising, at the computing device, generating a user interface including a prompt to confirm learning of the relationship.

12. The method of claim 9 further comprising, at the computing device, causing the program to also perform the action upon receipt of the first sequence of inputs from the at least one input device while accessing the virtual computing session.

13. The method of claim 9 further comprising, at the computing device, communicating with a management service to remotely store the learned action for use on other computing devices.

14. The method of claim 9 wherein the at least one input device comprises at least one of an audio input device, a motion sensor, and a keypad.

15. A non-transitory computer-readable medium having computer-executable instructions for causing a computing device to perform steps comprising:
running a program;
receiving a first sequence of inputs from at least one input device for the program;
learning a relationship between an action performed by the program and the first sequence of inputs;
accessing a remote virtual computing session in which the action is performed responsive to a second sequence of inputs different than the first sequence of inputs; and
upon receipt of the first sequence of inputs from the at least one input device while accessing the remote virtual computing session, causing the virtual computing device to perform the action based upon the learned relationship.

16. The non-transitory computer-readable medium of claim 15 wherein learning comprises learning the relationship upon receiving the first sequence of inputs a plurality of times.

17. The non-transitory computer-readable medium of claim 15 further having computer-executable instructions for causing the computing device to perform a step of generating a user interface including a prompt to confirm learning of the relationship.

18. The non-transitory computer-readable medium of claim 15 further having computer-executable instructions for causing the computing device to perform a step of causing the program to also perform the action upon receipt of the first sequence of inputs from the at least one input device while accessing the virtual computing session.

19. The non-transitory computer-readable medium of claim 15 further having computer-executable instructions for causing the computing device to perform a step of communicating with a management service to remotely store the learned action for use on other computing devices.

20. The non-transitory computer-readable medium of claim 15 wherein the at least one input device comprises at least one of an audio input device, a motion sensor, and a keypad.
